(19) United States
(12) Patent Application Publication
(10) Pub. No.: US 2020/0011230 A1
(43) Pub. Date: Jan. 9, 2020

(54) METHOD OF OPERATING AN INTERNAL COMBUSTION ENGINE, AN INTERNAL COMBUSTION ENGINE AND A MOTOR VEHICLE

(71) Applicant: Volkswagen Aktiengesellschaft, Wolfsburg (DE)

(72) Inventors: Dirk HAGELSTEIN, Braunschweig (DE); Javier BARTOLOME, Braunschweig (DE)

(73) Assignee: Volkswagen Aktiengesellschaft, Wolfsburg (DE)

(21) Appl. No.: 16/504,107

(22) Filed: Jul. 5, 2019

(30) Foreign Application Priority Data
Jul. 5, 2018 (DE) 10 2018 211 094.8

(51) Int. Cl. F02B 37/16; F02D 41/00; F02B 37/22; F04D 29/46

(52) U.S. Cl. CPC F02B 37/162; F02D 41/0007; F02B 2039/166; F04D 29/462; F02B 37/225

(57) ABSTRACT

A method of operating an internal combustion engine, wherein the internal combustion engine has at least one combustion engine, a fresh gas line, and a compressor integrated in the gas line, which is associated with a trim controller, via which an edge-side portion of the inlet cross section of a compressor impeller of the compressor is coverable to a variable extent. In this case, in a release position of the trim controller, the edge-side portion of the inlet cross section is covered relatively little, and in a covering position of the trim controller, is mostly covered. It is provided that in a transition from a traction mode of the combustion engine, in which the trim controller is in the release position, the trim controller is adjusted to an overrun mode of the combustion engine into the covering position. As a result, a so-called discharge hissing can be prevented or minimized.

This nonprovisional application claims priority under 35 U.S.C. § 119(a) to German Patent Application No. 10 2018 211 094.8, which was filed in Germany on Jul. 5, 2018, and which is herein incorporated by reference.

### BACKGROUND OF THE INVENTION

### Field of the Invention

The present invention relates to a method for operating an internal combustion engine and to an internal combustion engine suitable for carrying out such a method. The invention also relates to a motor vehicle having such an internal combustion engine.

### Description of the Background Art

In a compressor of an internal combustion engine, the fresh gas to be supplied to the combustion engine of the internal combustion engine is compressed via a fresh gas line. In this case, the increase in pressure of the fresh gas is dependent on the rotational speed of the compressor impeller as well as on the mass flow of the fresh gas guided through the compressor impeller. In the direction of the so-called surge line of the compressor map, the inflow of the inlet edges of the impeller blades takes place increasingly on the pressure side as a result of the flow velocity decreasing relative to the peripheral speed, i.e., the incidence of the inflow increases steadily. From an operating point-dependent limit value of the incidence, the so-called surge line, the inflow at the inlet edges separates and the flow in the compressor becomes unstable. In the area of the surge line, a recirculation zone of low-impulse fluid forms on the inlet side housing contour of the compressor. This so-called recirculation bubble leads to a drop in compressor efficiency due to swirling and mixing losses. In the region of the hub contour of the impeller, however, an high-impulse and low-loss core flow runs through the compressor close to the surge line, which determines the mass flow rate and the pressure build-up.

A trim controller as is known, for example, from DE 10 2010 026 176 A1, EP 3 018 355 A1, DE 10 2015 209 704 A1, DE 10 2014 225 716 A1 or WO 2014/131790 A1, is used for the displacement of the surge line of a compressor map in the direction of relatively low mass flows at relatively high pressure conditions. At the same time, a trim controller can cause an increase in compressor efficiency in the surge line area. For this purpose, a trim controller comprises a device by means of which the inflow cross section, in which the impeller of the compressor is supplied air, can be changed. By means of the thus achieved nozzle action of the trim controller, with increasing control intervention (reduction of the inflow cross section), the gas flow can be focused more on the inlet cross section of the compressor impeller close to the hub. As a result, less gas flows into the low-impulse region of the recirculation bubble that is subject to loss, and the core flow in the region close to the hub is accelerated and additionally stabilized thereby. The acceleration of the gas flow in the hub-proximal region of the compressor impeller additionally results in displacement on the intake side of the inflow on the compressor impeller, which may contribute to further stabilization of the gas flow. The stabilization of the core flow leads to the desired displacement of the surge line of the compressor map to lower mass flows. If there is an undesired control intervention (trim controller is fully open), if possible, the entire no additional friction or throttle losses occur in the inflow on the compressor impeller present at that time. The trim controller does therefore not significantly adversely affect the compressor efficiency and the width of the compressor map in the direction of the choke line.

The possibility of recirculating already compressed fresh gas due to the incomplete separation of the high pressure and the low pressure sides from each other by the compressor impeller, which results from the compressors in the form of turbo compressors customary in vehicle design, can also be problematic if a throttle valve integrated in the charge-air duct, which was previously opened wide, is closed quickly. This is the case in the transition from a traction mode to an overrun mode of the internal combustion engine. The inertia of the system “internal combustion engine” can then cause the compressor to initially continue to boost into the charge-air duct, which has already been interrupted by the closed throttle valve with possibly high compression performance, resulting in a correspondingly high compressor pressure ratio while maintaining a very low mass flow of fresh gas through the compressor. These conditions favor a recirculation of compressed fresh gas via the compressor impeller which is then not driven or only driven at low speeds.

Such recirculating fresh air can propagate in a wave-like manner, which can lead to a corresponding vibration excitation of components of the fresh gas line upstream of the compressor impeller. The noise associated with this vibration excitation is often referred to as “discharge hissing”.

Such discharge hissing can be prevented by integrating a wastegate in the compressor. In this case this is a bypass line, which if necessary is releasable or closable by means of a (diverter) valve and which connects a portion of the flow path in the compressor downstream of the compressor impeller with a portion upstream of the compressor impeller. A relatively high compressor pressure ratio across the compressor impeller, which could lead to discharge hissing, can be reduced by means of such a wastegate by correspondingly opening the diverter valve. However, the cost of such a wastegate is relatively high.

Furthermore, the integration of sound-insulating elements in that section of the fresh gas line which is upstream with respect to the compressor inlet may be provided in order to minimize the effects of vibration excitation and thus discharge hissing. But this is also associated with relatively high costs. In addition, such a measure usually requires a relatively large amount of space.

WO 2004/022956 A1 discloses a method by which the operation of a compressor of an internal combustion engine is to be avoided in the region of the surge line. According to the invention, the behavior of the compressor is monitored for the characteristic vibration behavior of the fresh gas flowing through the intake port by means of an air flow sensor disposed in an intake port of the internal combustion engine. If a short-term threat of reaching the surge line is determined in this way, for example, the value for the target boost pressure to be achieved is reduced, for which purpose an exhaust gas turbine driving the compressor is supplied air in a correspondingly modified manner by means of adjusting a device for a variable turbine geometry (VTG).

### SUMMARY OF THE INVENTION

It is therefore an object of the present invention to provide an internal combustion engine supercharged by a compressor, which is characterized by a performance that is as optimal as possible, particularly with respect to the acoustic behavior.

In an internal combustion engine supercharged by a compressor in which the compressor is assigned a trim controller to improve its operating performance, the invention is based on the idea of also actively using the trim controller in order to avoid or at least minimize the discharge hissing that can occur in supercharged internal combustion engines when transitioning from the traction mode to the overrun mode.

Accordingly, a method is provided for operating an internal combustion engine, wherein the internal combustion engine comprises at least one combustion engine and a fresh gas line, wherein a compressor is integrated in the fresh gas line, which is associated with a trim controller, by means of which an edge-side portion of the inlet cross section of a compressor impeller of the compressor can be covered to varying degrees. In this case, in a release position of the trim controller, the edge-side portion of the inlet cross section is covered relatively little, preferably the least possible (i.e., as little as possible as is maximally determined by the structural design), and in a covering position of the trim controller, fairly substantially, preferably as much as possible (i.e., to such an extent as determined by the structural design to be maximally possible). The invention provides that the trim controller is adjusted position when transitioning from a traction mode of the combustion engine, in which the trim controller is in the released position, to an overrun mode of the combustion engine.

In this case, the traction mode of the combustion engine is characterized in that it is operated under load and thus, drive power is generated thereby. In contrast, the overrun mode is characterized in that no load request is made to the combustion engine and that the latter is driven. In the preferred integration of an internal combustion engine according to the invention in a motor vehicle, such a drive of the combustion engine takes place, in particular, by rolling the motor vehicle with an uninterrupted drive train.

In an internal combustion engine according to the invention, such a transition from a traction mode to the overrun mode can be connected in particular with a complete or a greatest possible closing of a throttle valve integrated into the charge-air duct (the portion of the fresh gas line which connects the compressor with the combustion engine).

The adjustment of the trim controller can take place preferably directly with the load removal, by which the transition from the traction mode to the overrun mode is characterized, or with the beginning of an associated closing movement of the throttle valve. It is also possible to initiate the adjustment of the trim controller with a command for load removal, for example by relieving an accelerator pedal of a motor vehicle comprising an inventive internal combustion engine, which may be slightly time-delayed with respect to the load removal actually carried out by a control device of the internal combustion engine and/or a closing of the throttle valve. However, a slightly time-delayed adjustment of the trim controller is also possible, for example, up to a maximum of 0.3 seconds after the transition from the traction mode to the overrun mode.

The trim controller of an inventive internal combustion engine can be actively moved position when as a result of a transition from the traction mode to the overrun mode, it is possible that an edge-side recirculation of previously compressed fresh gas takes place from the high pressure side to the low pressure side of the compressor. The trim controller, which then largely covers the edge-side portion of the inlet cross section of the compressor impeller, prevents or interferes with such a recirculation or with the further propagation thereof in the portion of the fresh gas line located upstream of the trim controller, whereby vibration excitations, which would lead to a discharge hissing, can be prevented or minimized.

An internal combustion engine suitable for the automated execution of a method according to the invention comprises at least one combustion engine (in particular a spark-ignition engine or a further, at least partially spark-ignited and quantity-controlled combustion engine) and a fresh gas line, wherein a compressor is integrated in the fresh gas line and wherein the compressor is assigned a trim controller, by means of which an edge-side portion of the inlet cross section of a compressor impeller of the compressor can be covered to a varying extent. In this case, in a release position of the trim controller, the edge-side portion of the inlet cross section is covered relatively little, preferably as little as possible, and in the covering position of the trim controller, relatively substantially, preferably as much as possible. Furthermore, such an internal combustion engine comprises a control device which is set up for the automated execution of a method according to the invention.

The “inlet plane” of the compressor impeller can be understood to be the plane closest to the trim controller that is oriented perpendicular to the rotational axis of the compressor impeller, which is defined by impeller blades of the compressor impeller, in that at least one punctiform portion of one, more or all of the leading edges of said impeller blades are arranged within that plane. The “inlet cross section” of the compressor impeller can be the opening cross section of the flow space located in this inlet plane.

The trim controller of an internal combustion engine according to the invention can in principle be arbitrary configured, for example according to one of the embodiments as disclosed in DE 10 2010 026 176 A1, EP 3 018 355 A1, DE 10 2015 209 704 A1, DE 10 2014 225 716 A1 or WO 2014/131790 A1, which are incorporated herein by reference.

The trim controller of an inventive internal combustion engine comprises an annular diaphragm. The diaphragm can, for example, be designed in the form of an iris diaphragm as it is basically known from photo lenses. Alternatively, the diaphragm may also include in particular an annular stator and in particular an annular rotor, which are arranged side by side in the longitudinal axial direction, wherein both the stator and the rotor in each case form at least one through-opening, and which by rotation of the rotor relative to the stator can be moved to different relative positions, in which these do not, partially or completely overlap. A trim controller which comprises only one such diaphragm can be characterized by a relatively simple structural design.

The trim controller can comprise a flow guide device, by means of which at least a portion of the fresh gas line is divided into a central flow region and a peripheral flow region, which in the area of the inlet plane of the compressor impeller both merge into a flow space of the compressor receiving the compressor impeller, wherein the peripheral flow region is closable by means of the diaphragm. The diaphragm may preferably be arranged at the upstream end of the peripheral flow region. By means of such a combination of diaphragm and flow guide device, as compared to a trim controller comprising only an annular diaphragm, the function of the trim controller can be improved both with respect to the effects on the compressor map and with respect to suppressing the discharge hissing.

The function of such a trim controller with diaphragm and flow guide device can be even further improved when at least one end portion of the flow guide device adjacent to the compressor impeller, optionally the entire flow guide device, is designed to be longitudinally axially slidable (i.e., along the rotational axis of the compressor impeller), wherein in the region of the inlet plane of the compressor impeller, the peripheral flow region is closed by said end portion in a closed position of the flow guide device, and is released in an open position.

In a continuing traction mode, the trim controller can be moved back to the release position upon reaching a defined limit value. This can serve, in particular, to relieve an actuator that is provided for actuating the trim controller, or to not burden it unnecessarily long. Such an approach may be provided in particular in an embodiment of the trim controller of an internal combustion engine according to the invention, which is selected such that in the absence of activation by the control device, the trim controller is automatically urged by a reset device, which may be in particular in the form of a spring element, into a/the release position in which the trim controller covers the edge-side portion of the inlet cross section as little as possible. By means of such an embodiment of the trim controller, in particular a so-called fail-safe functionality can be realized, since in a failure of the control device or the actuator actuating the trim controller, the reset device moves the trim controller into the release position, covering the inlet cross section as little as possible and thereby ensuring the emergency operation of the compressor with the least impaired functionality.

The limit value, which when reached causes the trim controller to preferably be adjusted back to the release position, is preferably defined such that, when it is reached, it is no longer necessary to assume the danger of discharge hissing occurring. In particular, the limit value can define a timing so that the trim controller is moved back to the release position at a defined time after transitioning from the traction mode to the (continuing) overrun mode and after the adjustment of the trim controller provided according to the invention from the release position and back to the release position, because it can be assumed that the gas pressures on the high-pressure side and the low-pressure side of the compressor are sufficiently matched. Also, the limit value may advantageously define a gas pressure (as absolute pressure or relative pressure or differential pressure) in the fresh gas line, so that the trim controller is (again) adjusted to the release position when sufficient equalization of the gas pressure on the high pressure side and the low pressure side of the compressor has been reached.

The compressor of an inventive internal combustion engine can in particular be part of an exhaust gas turbocharger, further comprising an exhaust gas turbine integrated in the exhaust line, wherein the preferably provided exhaust gas recirculation line can in particular branch off from the exhaust gas line downstream of the exhaust turbine. The compressor is then driven by means of the exhaust gas turbine using the exhaust gas enthalpy. Alternatively, or additionally, the compressor can also be designed to be powered in another way, for example by the combustion engine, i.e., mechanically, or by means of an electric motor.

An inventive internal combustion engine can be in particular a part of an (inventive) motor vehicle. In this case, the combustion engine of the internal combustion engine can in particular be provided to directly or indirectly provide drive power for the motor vehicle.

Such an inventive motor vehicle can in particular be a wheel-based, non-rail vehicle (preferably a car or a truck).

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrates an internal combustion engine according to the invention;

FIG. 2 illustrates a longitudinal section through a compressor for an internal combustion engine according to FIG. 1 with an associated trim controller in a position covering the inlet cross section of a compressor impeller as little as possible;

FIG. 3 illustrates the compressor according to FIG. 2 with the trim controller in a position covering the inlet cross section of the compressor impeller as much as possible; and

FIG. 4 illustrates in a total of four diagrams, the waveforms of various parameters during a portion of an operation of an inventive internal combustion engine, which comprises a transition from the traction mode to the overrun mode.

### DETAILED DESCRIPTION

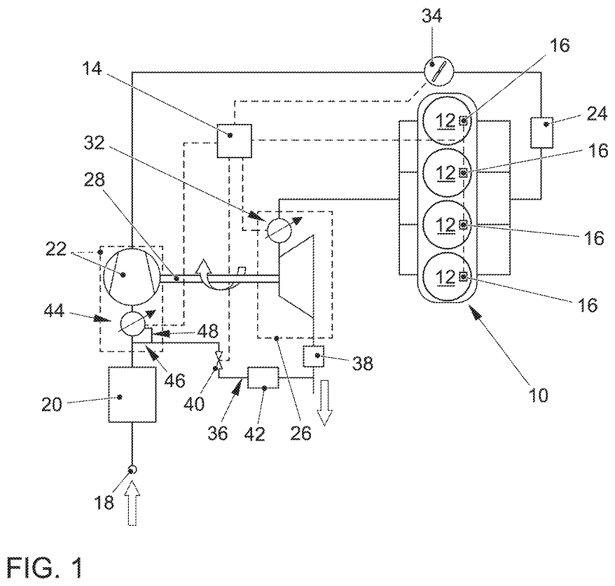

FIG. 1 shows a schematic representation of an inventive internal combustion engine with a combustion engine 10 embodied as a spark-ignited motor, comprising a plurality of cylinders 12. The cylinders 12, together with pistons guided up and down therein and a cylinder head, define combustion chambers in which fresh gas is combusted together with fuel. The fuel, controlled by a control device 14 (engine control), is injected directly into the combustion chambers by means of injectors 16. The combustion of the fuel fresh gas mixture amounts leads to cyclic up and down movements of the pistons, which in turn are transferred in a known manner via connecting rods to a crankshaft, whereby the crankshaft is driven in rotation.

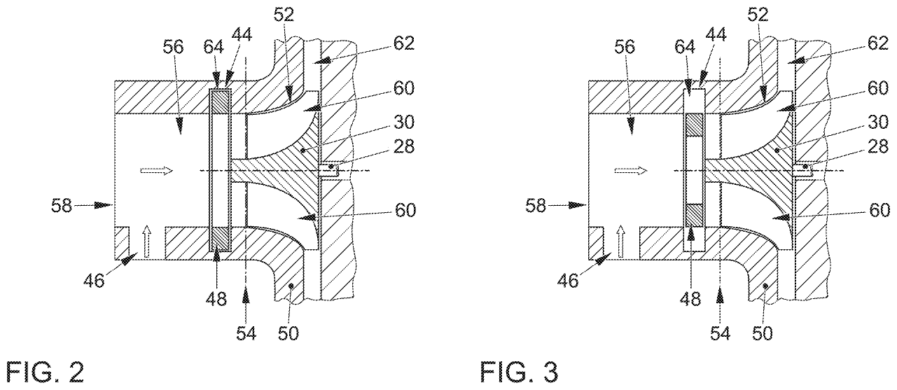

The fresh gas is supplied to the engine 10 via a fresh gas line and is aspirated from the environment via an intake port 18, cleaned in an air filter 20 and then fed into a compressor 22, which is part of an exhaust gas turbocharger. The fresh gas is compressed by means of the compressor 22, then cooled in a charge-air cooler 24 and finally fed to the combustion chambers. The compressor 22 is driven by means of an exhaust gas turbine 26 of the exhaust gas turbocharger, which is integrated into an exhaust line of the internal combustion engine. Exhaust gas formed by the fuel fresh gas mixture amounts in the combustion chambers of the engine 10 is discharged through the exhaust line from the combustion engine 10 and thereby flows through the exhaust gas turbine 26. This leads in a known manner to a rotating drive of a turbine impeller, which is non-rotatably connected via a shaft 28 to a compressor impeller 30 (see FIGS. 2 and 3) of the compressor 22. The rotating drive of the turbine impeller is thus transferred to the compressor impeller 30.

In order to optimally implement the enthalpy of the exhaust gas for producing compression performance by means of the exhaust gas turbocharger during operation of the engine 10 at varying loads and speeds, the exhaust gas turbine 26 of the exhaust gas turbocharger may optionally comprise a device for variable turbine geometry (VTG) 32, which is controllable by means of the control device 14. This may comprise in a known manner a plurality of guide blades, which are arranged in an inlet channel of the exhaust gas turbine 26 and which are individually rotatable, wherein these may be adjusted together by means of an adjusting device. As a function of the rotational positions of the guide blades, these more or less narrow the free flow cross section in the inlet channel of the exhaust gas turbine 26 and also influence the portion of the primary flow of the turbine impeller and the orientation of this flow.

A throttle valve 34, likewise controllable by means of the control device 14, is integrated downstream of the compressor 22 in the charge-air duct, i.e. in the portion of the fresh gas line which is located between the compressor 22 and the engine 10.

The internal combustion engine may comprise an exhaust gas recirculation line 36 to recirculate (low pressure) exhaust gas, in which the exhaust gas is branched off from a portion of the exhaust gas line, which is located downstream of the exhaust gas turbine 26 and, in particular, also downstream of an exhaust gas aftertreatment device 38, such as a particulate filter, and is introduced into a section of the fresh gas line upstream of the compressor impeller 30. The amount of exhaust gas recirculated via the exhaust gas recirculation line 36 can in this case be controlled or regulated by means of a control valve 40 which is controllable by means of the control device 14. Further, an exhaust gas cooler 42 may be integrated in the exhaust gas recirculation line 36 for cooling the exhaust gas recirculated through it.

The compressor 22 is associated with a trim controller 44 by means of which the incident flow of the compressor impeller 30 can be influenced by the fresh gas. For this purpose, the trim controller 44 or an associated actuator can be controlled by means of the control device 14. The exhaust gas recirculation line 36 may end in the fresh gas line upstream or on the side of the trim controller 44 facing away from the compressor impeller 30. An orifice downstream or in the region of the trim controller 44 (and upstream of the compressor impeller 30) is also possible.

In a longitudinal section, FIGS. 2 and 3 each show a possible embodiment for an inventive compressor 22. This compressor 22 may be provided, for example, for an internal combustion engine according to FIG. 1, wherein the trim controller 44 and a connection channel 46 for the exhaust gas recirculation line 36 are integral parts of the compressor 22. This is indicated in FIG. 1 by a dashed border.

The compressor 22 according to FIGS. 2 and 3 includes a housing 50, which may constitute a partial housing of an overall housing of an exhaust gas turbocharger. The housing 50 of the compressor 22 forms a flow space 52 within which the compressor impeller 30 is rotatably mounted. On the inlet side, the flow space 52 has an inlet cross section located in an inlet plane 54. Via an inlet channel 56 likewise formed by the housing 50 of the compressor 22, fresh gas can be guided from a compressor inlet 58 to the compressor impeller 30. On the outlet side, the flow space 52 is limited by an “outlet plane” surrounding outlet edges of impeller blades 60 of the compressor impeller 30. There, it is adjoined by a diffuser space 62 also surrounding the outlet edges of the impeller blades 60, and adjoining that, which is in FIGS. 2 and 3, is a compressor volute. A compressor outlet branches off from the compressor volute.

Within the inlet channel 56, the trim controller 44 is arranged as closely as possible to the inlet cross section of the compressor impeller 30. The trim controller 44 includes an iris diaphragm 48 with a structure basically known from photo lenses. In a covering position according to FIG. 3, in a peripherally located annular area of the inlet cross section, the trim controller 44 mostly prevents an inflow of fresh gas flowing in the direction of the compressor impeller 30 to the compressor impeller 30. In this way, the trim controller 44 focuses this fresh gas flow on a hub-proximal portion of the compressor impeller 30. In a release position according to FIG. 2, however, the fresh gas can flow into the compressor impeller 30 over the entire inlet cross section. The diaphragm elements forming the iris diaphragm 48, which are each pivotably mounted about an axis within the housing 50 for opening or closing the iris diaphragm 48, in the release position are arranged completely in an annular recess 64 of the housing 50.

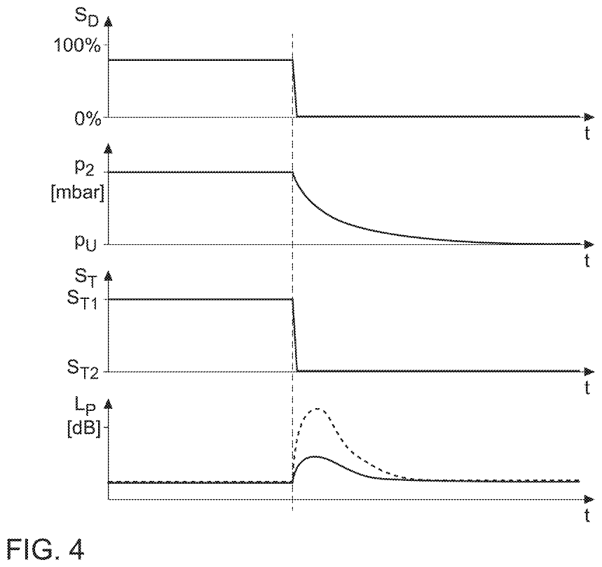

According to the invention, it is provided that during the operation of an internal combustion engine according to FIG. 1, when transitioning from the traction mode of the combustion engine 10 in which the trim controller 44 is in the release position according to FIG. 2, the trim controller 44 is always moved to an overrun mode to a covering position according to FIG. 3 in order to prevent or at least minimize discharge hissing. FIG. 4 clarifies this process based on four graphs, which show by way of example concurrent waveforms of different characteristics during a portion of the operation of the internal combustion engine involving such a transition from the traction mode to the overrun mode.

In each case, the top diagram of FIG. 4 shows the percentage open position S_{D} of the throttle valve 34, wherein the throttle valve 34 is opened the farther, the higher the percentage open position. Accordingly, during a traction mode of the combustion engine 10, the throttle valve 34 is at least partially opened, whereas it is completely closed for an overrun mode of the combustion engine 10 (open position: 0%). The trajectory in the uppermost diagram of FIG. 4 thus shows a transition from a traction mode of the combustion engine 10 to an overrun mode, wherein this transition, characterized by a complete removal of the load with which the combustion engine 10 is operated, is marked by a vertically extending, dashed line. From this transition on, the throttle valve 34 is moved as quickly as possible to the fully closed position.

The complete load removal for the operation of the combustion engine 10, which characterizes the transition from a traction mode to an overrun mode, causes the drive power of the exhaust gas turbine 26 and thus the compression performance of the compressor 22 to drop relatively quickly. The relatively high pressure p₂ in the charge-air duct of the fresh gas line, which was previously effected in the traction mode by the relatively high compression performance, does not decrease correspondingly faster since the possibility of outflow of the compressed fresh gas into the combustion engine 10 is not possible due to the closed throttle valve 34. Therefore, by a recirculation of compressed fresh gas, there is a reduction in the pressure difference between the high pressure side and the low pressure side of the compressor via the compressor impeller 30 rotating only at relatively low speed. The upper of the two middle diagrams of FIG. 4 illustrates this relatively slow pressure loss in the charge-air duct (until the ambient air pressure pᵤ is almost reached) after a transition from the traction mode to the overrun mode.

The recirculation of compressed fresh gas from the high pressure side to the low pressure side of the compressor 22 causing this pressure loss in the charge-air duct can lead to discharge hissing since pressure oscillations can superimpose the average boost pressure shown in the upper middle graph of FIG. 4 and these pressure vibrations can lead to vibration excitations of components of the fresh gas line situated upstream of the compressor impeller.

The lowest graph in FIG. 4 illustrates this effect on the basis of progressions for the sound pressure level L_{P} (in dB) measured at a location outside the fresh gas line near the compressor inlet 58. In this case, the course for the sound pressure level L_{P} is shown on the one hand with dashed lines, which ensues when in a transition from the traction mode to the overrun mode according to FIG. 4, the trim controller 44, which was set to a release position (covering as little as possible) during the traction mode according to FIG. 2, is left in this release position. A significantly higher sound pressure level L_{P} is apparent shortly after the transition from the traction mode to the overrun mode, as compared to an inventive process (compare the course in the lowest diagram of FIG. 4 with the continuous lines), in which according to the lower of the two middle diagrams of FIG. 4, the trim controller 44 previously set to the release position S_{T1} is adjusted simultaneously with the transition from the traction mode to the overrun mode in the covering position S_{T2} (covering as much as possible) according to FIG. 3.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating an internal combustion engine, the method comprising:
providing a combustion engine and a fresh gas line, wherein a compressor is integrated in the fresh gas line and wherein the compressor is associated with a trim controller via which an edge-side portion of the inlet cross section of a compressor impeller of the compressor is adapted to be covered to a variable extent, wherein in a release position of the trim controller, the edge-side portion of the inlet cross section is covered relatively little and in a covering position of the trim controller, the edge-side portion is mostly covered;
adjusting the trim controller to an overrun mode of the combustion engine into the covering position, in a transition from a traction mode of the combustion engine, in which the trim controller is in the release position.

2. The method according to claim 1, wherein, in the covering position, the trim controller covers the edge-side portion of the inlet cross section as much as possible.

3. The method according to claim 1, wherein the trim controller is again adjusted to the release position upon reaching a defined limit value.

4. The method according to claim 3, wherein the limit value defines a timing or a gas pressure in the fresh gas line.

5. An internal combustion engine comprising:
a combustion engine;
a fresh gas line;
a compressor integrated in the fresh gas line, wherein the compressor is associated with a trim controller via which an edge-side portion of the inlet cross section of a compressor impeller of the compressor is covered to a varying extent, wherein in a release position of the trim controller, the edge-side portion of the inlet cross section is covered relatively little, and in a covering position of the trim controller, is mostly covered; and
a control device which is adapted for an automated execution of the method according to claim 1.

6. The internal combustion engine according to claim 5, wherein the trim controller comprises an annular diaphragm (48).

7. The internal combustion engine according to claim 6, wherein the trim controller additionally comprises a flow guide device by means of which at least a portion of the fresh gas line is divided into a central flow region and a peripheral flow region, both transitioning into a flow space of the compressor in the area of the inlet plane of the compressor impeller, wherein the peripheral flow region is formed to be closeable via the diaphragm.

8. The internal combustion engine according to claim 7, wherein at least an end portion of the flow guide device located adjacent to the compressor impeller is formed to be longitudinally axially displaceable, wherein the peripheral flow region in the region of the inlet plane of the compressor impeller is closed in a closed position of the flow guide device via this end portion and is released in an open position.

9. The internal combustion engine according to claim 5, wherein, in an absence of activation by the control device, the trim controller is moved into a release position by means of a reset element in which the trim controller covers the edge-side portion of the inlet cross section as little as possible.

10. A motor vehicle comprising an internal combustion engine according to claim 5.
